(19) United States
(12) Patent Application Publication
(10) Pub. No.: US 2008/0002158 A1
(43) Pub. Date: Jan. 3, 2008

(54) Projection Device

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/770,797

(22) Filed: Jun. 29, 2007

(30) Foreign Application Priority Data
Jun. 30, 2006 (JP) 2006-181749

(51) Int. Cl. G03B 21/28

(52) U.S. Cl. 353/77

(57) ABSTRACT

There is provided a projection device having an optical projection system, a curved mirror, a screen, and a light guiding unit. A cross sectional shape of the curved mirror in an X-Z plane has a negative power, and the curved mirror is fixed to the projection device through at least one predetermined fixing point. A cross sectional shape of the curved mirror in an X-Y plane including a deformation reference point defined based on the at least one fixing point has its maximum negative power in a vicinity of the deformation reference point. A sag amount x=f(y) defined in an x-y coordinate having an origin point at the deformation reference point in the X-Y plane satisfies a following expression:

for ymax/2≦y≦ymax,

|f″(ymax)|≦|f″(y)|≦|2f″(ymax)|

### BACKGROUND OF THE INVENTION

The present invention relates to a projection device employing a curved mirror and an optical projection system.

Recently, attention is being given to a thin type monitor having a wide screen, such as a liquid crystal monitor, a PDP Plasma Display Panel), and a rear projection monitor. The rear projection monitor is configured such that an image formed by a transmissive image forming device (e.g., a compact transmissive liquid crystal display) or a reflective image forming device (e.g., a micromirror device) is projected onto a rear surface of the screen. The rear projection monitor has advantages that weight reduction and reduction in thickness can be achieved relatively easily. For example, it is expected that the rear projection monitor can be implemented as a wall-hung television.

Japanese Patent Provisional Publication No. HEI 6-11767 (hereafter, referred to as JP HEI 6-11767A) discloses a projection device configured to have a curved mirror on an optical path between an optical projection system and a screen.

In general, a reflection mirror formed by evaporating particles of metal such as aluminium on a surface of a plate of plastic such as polycarbonate, chloroethene, acrylate resin, or methacrylate is employed in a projection device. The reflection mirror made of plastic has a drawback that a linear expansion coefficient (approximately 7×10⁻⁵/° C.) is several hundred times as large as that of a mirror made of glass, although the reflection mirror made of plastic has advantage that it can be relatively easily produced to have desired optical performance at low cost.

The projection device needs to employ a high heat-producing light source such as a halogen lamp. Therefore, temperature in the projection device may increase by several tens of degrees in a relatively short time period. Since as described above plastic has a relatively high linear expansion coefficient, a possibility that the reflection mirror is deformed by the temperature increases inadmissibly. Therefore, if a reflection mirror made of plastic is used in the projection device disclosed in JP HEI 6-11767A, an image projected on the screen may be deformed by deformation of the reflection mirror due to temperature increase in the projection device.

### SUMMARY OF THE INVENTION

The present invention is advantageous in that it provides an projection device having a curved mirror capable of forming a projection image which is not deformed by temperature changes.

According to an aspect of the invention, there is provided a projection device, which is provided with an optical projection system from which a light beam for forming an image emerges, a curved mirror on which the light beam from the optical projection system impinges, a screen having a landscape rectangular shape, and a light guiding unit that guides the light beam reflected from the curved mirror to the screen. In this configuration, a direction corresponding to a thickness of the screen is defined as a X-direction, a direction corresponding to a shorter side of the screen is defined as a Y-direction, and a direction corresponding to a longer side of the screen is defined as a Z-direction.

Further, a cross sectional shape of the curved mirror in an X-Z plane has a negative power in a range within which the light beam from the optical projection system impinges, and the curved mirror is fixed to the projection device through at least one predetermined fixing point. A cross sectional shape of the curved mirror in an X-Y plane including a deformation reference point defined based on the at least one fixing point has its maximum negative power in a vicinity of the deformation reference point A sag amount x=f(y) which is a sag amount of the cross sectional shape of the curved mirror in the X-Y plane and which is defined in an x-y coordinate having an origin point at the deformation reference point in the X-Y plane satisfies a following expression:

for ymax/2≦y≦ymax,

|f″(ymax)|≦|f″(y)|≦|2f(ymax)|

where y represents an axis tangential to the cross sectional shape in the X-Y plane at the deformation reference point, x represents a normal to the cross sectional shape in the X-Y plane at the deformation reference point, f″(y) represents a second derivative of f(y) with respect to y, and yₘₐₓ represents a value of y on the curved mirror at a point furthest from the deformation reference point in a use range of the curved mirror.

Such a configuration makes it possible to suppress change in curvature of the curved mirror due to neat expansion to a low level in a region far from the deformation reference point. Therefore, it is possible to prevent a projection image from being deformed by temperature changes.

Optionally, for yₘₐₓ/2≦y≦yₘₐₓ, the sag amount of the curved surface in the X-Y plane satisfies a condition:

$$\vert {f}^{″} ( y max ) \vert \leq \vert {f}^{″} ( y ) \vert \leq \vert 2 {f}^{″} ( y max ) \vert - \vert \frac{y}{y max} {f}^{″} ( y max ) \vert$$

Optionally, the optical projection system is arranged in relation to the curved mirror such that the light beam from the optical projection system forms its minimum incident angle with respect to the curved mirror in the vicinity of the deformation reference point.

Optionally, the curved mirror is formed to be a rotationally symmetrical shape and a rotation axis of the curved mirror passes through the deformation reference point.

Optionally, the deformation reference point is located in the X-Y plane including a center of the screen.

Optionally, the at least one predetermined fixing point comprises two fixing points respectively located at a same distance in the Z-direction from an intersection line of the X-Y plane including a center of the screen and the curved surface.

Optionally, the at least one predetermined fixing point is defined as an entire part of a predetermined edge region of the curved mirror situated on a bottom side of the projection device.

Optionally, the projection device may include a case that accommodates the optical projection system and the curved mirror. In this case, the screen is placed on a side of the case, and the light guiding unit is attached to a top of the case.

### BRIEF DESCRIPTION OF THE ACCOMPANYING DRAWINGS

FIG. 1 is a perspective view of a projection device according to an embodiment.

FIG. 2 is a cross-sectional view of the projection device in an X-Y plane.

FIGS. 3A to 3C illustrate examples of installation of a second mirror provided in the projection device.

FIG. 4 illustrates a cross sectional shape of the second mirror.

FIG. 5 is a graph illustrating a cross sectional shape of the second mirror according to a first example.

FIG. 6 is a graph representing the changing amount of curvature of the second mirror according to the first example defined when the temperature increases by 30° C. from the room temperature.

FIG. 7 is a graph illustrating a cross sectional shape of the second mirror according to a second example.

FIG. 8 is a graph representing the changing amount of curvature of the second mirror according to the second example defined when the temperature increases by 30° C. from the room temperature.

FIG. 9 is a graph illustrating a cross sectional shape of the second mirror according to a third example.

FIG. 10 is a graph representing the changing amount of curvature of the second mirror according to the third example defined when the temperature increases by 30° C. from the room temperature.

FIG. 11 is a graph illustrating a cross sectional shape of the second mirror according to a fourth example.

FIG. 12 is a graph representing the changing amount of curvature of the second mirror according to the fourth example defined when the temperature increases by 30° C. from the room temperature.

### DETAILED DESCRIPTION OF THE EMBODIMENTS

Hereinafter, an embodiment according to the invention is described with reference to the accompanying drawings.

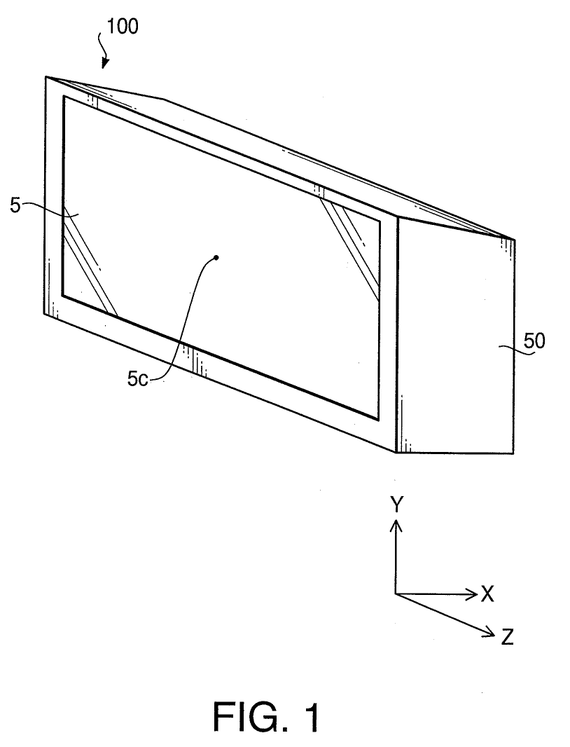

FIG. 1 is a perspective view of a rear projection monitor 100 (hereafter, simply referred to as a projection device 100) according to an embodiment, illustrating an outer appearance of the projection device 100 in a normal use state. As shown in FIG. 1, the projection device 100 has a box-shaped case 50 and a rectangular screen 5 mounted on the front of the case 50. In the normal use state, the projection device 100 is placed so that the screen 5 is in parallel with a vertical direction.

In the followings, a direction representing the thickness of the projection device 100 is defined as an X-direction, the vertical direction (i.e., a direction of the sorter side of the screen 5) is defined as a Y-direction, and a horizontal direction (i.e., a direction of the longer side of the screen 5) is defined as a Z-direction. Further, each of lengths of the projection device 100 or components in the projection device 100 in the X-direction is referred to as a depth, each of lengths of the projection device 100 or components in the projection device 100 in the Y-direction is referred to as a height, and each of lengths of the projection device 100 or components in the projection device 100 in the Z-direction is referred to as a width.

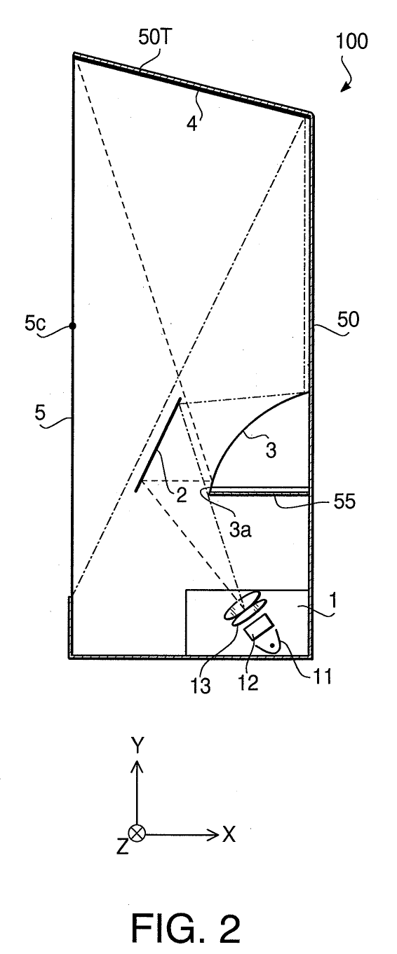

FIG. 2 is a cross-sectional view of the projection device 100 in an X-Y plane including a center 5c of the screen 5. Hereafter, the X-Y plane including the center 5c of the screen 5 is referred to as a reference plane. As shown in FIG. 2, the projection device 100 includes a projection unit 1, a first mirror 2, a second mirror 3, a third mirror 4 and the screen 5 which are placed in the case 5. The first and third mirrors 2 and 4 are flat mirrors. The second mirror 3 has an aspherical surface which is described in detail later. In FIG. 2 (and in the following drawings), a light ray which is part of light emerging from the projection unit 1 and which enters the lowermost position of the screen 5 is indicated by a chain line (which is referred to as a lowermost incident ray hereinafter), and a light ray which is part of light emerging from the projection unit 1 and which enters the uppermost position of the screen 5 is indicated by a dashed line (which is referred to as a uppermost incident ray hereinafter).

For the sake of simplicity, a surface on which the screen 5 is located is referred to as a front surface, a surface of the case 50 opposite to the screen 5 is referred to as a rear surface. Further, when the projection device 100 is in the normal use state, a surface of the screen 5 placed on an installation surface is referred to as a bottom surface, and a surface of the case 50 opposite to the bottom surface is referred to as a top surface.

The projection unit 1 includes a light source 11 such as a Xenon lamp emitting a high intensity light beam, an image formation device 12 such as a transmissive compact liquid crystal display 12, and an optical projection system 13. The optical projection system 13 is configured to project an image formed by the image formation unit 12 onto the screen 5. In the case 50, the projection unit 1 is located at a downward region on the rear side of the case 50.

The light beam emerging from the projection unit 1 proceeds to the screen 5. More specifically, the light beam emerging from the projection unit 1 impinges on the first mirror 2 located upwardly in a slanting direction with respect to the projection unit 1, and then the light beam is reflected by the first mirror 2 to proceed toward the rear surface of the case 5. The light beam reflected by the first mirror 2 is incident on the second mirror 3. Next, the light beam reflected by the second mirror 3 proceeds to the third mirror 4 mounted on the top surface 50T of the case 50. Finally, the light beam reflected by the third mirror 4 is incident on the screen 5 located downwardly in a slanting direction with respect to the third mirror 4.

The surface of the screen 5 is formed to be a Fresnel lens, and therefore the light beam obliquely impinging on the screen 5 is then refracted by the screen 5 to proceed in a direction perpendicular to the screen 5.

According to the above mentioned configuration of the projection device 100, a user is able to observe the image (which is projected on the screen 5 from the rear side) from the front side of the screen 5. The above mentioned configuration makes it possible to reduce the thickness of the case 50 while securing an optical path necessary for projection of an enlarged image.

As described above, the projection device 100 is designed based on a basic concept where the optical projection system is located on the rear side of the screen 5. However, it should be understood that the above mentioned configuration can also be applied to a projection device configured to project an image on a screen from the front side of the screen.

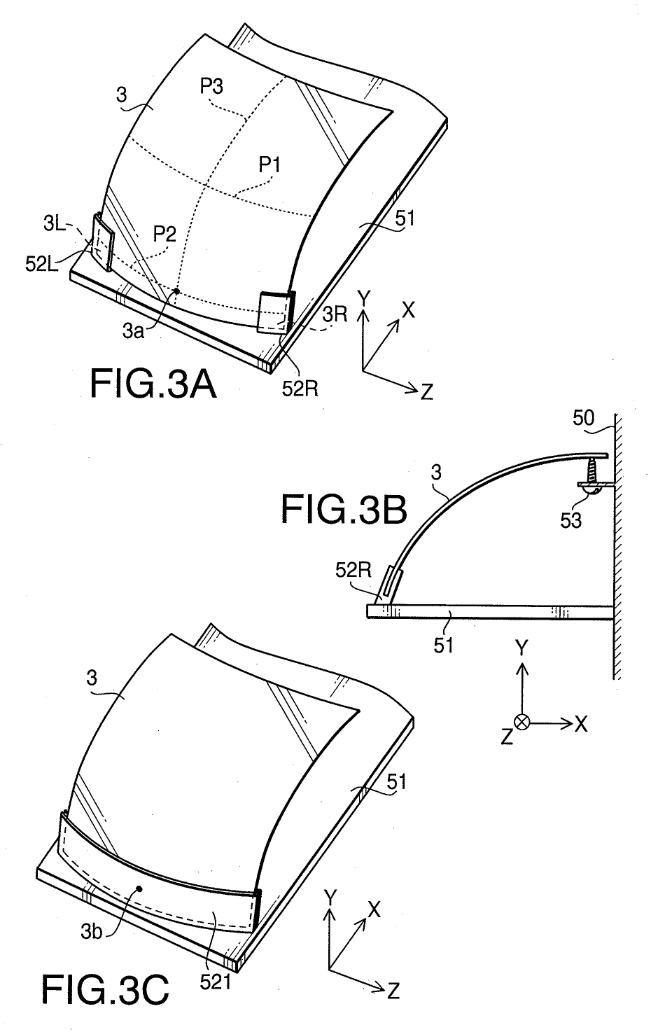

The second mirror 3 will now be described. FIG. 3A illustrates an example of installation of the second mirror 3. FIG. 3B is a side view of the second mirror 3 shown in FIG. 3A. For the purpose of explanation, the size in the Z-direction is reduced in FIGS. 3A and 3C. As shown in FIG. 3A, the second mirror 3 is attached to a mount 51 by fixing two corners 3L and 3R to the mount 51 with fixing members 52L and 52R. As shown in FIG. 3B, a rear edge part 3c of the second mirror 3 is supported by a tip of a supporting member 53 (e.g., a screw) which is fixed to a projection formed to protrude from the rear wall of the case 50. Through the fixing members 52L and 52R and the supporting member 53, the second mirror 3 is stably mounted in the case 50 in a state where the second mirror 3 is prevented from being damaged by deformation thereof caused by its own weight or thermal expansion.

The second mirror 3 has a negative power at least in the X-Z cross sectional plane. More specifically, the second mirror 3 is formed such that the curvature center of the shape in the X-Z cross sectional plane (i.e., the shape represented by a center line P1 in FIG. 3A) is situated on the rear side with respect to the front edge of the second mirror 3. The screen 5, the optical path of the light beam reflected by the second mirror 3, the front edge of the second mirror 3, and the curvature center of the second mirror 3 are arranged in this order from the front side. By thus employing the second mirror 3 having a negative power in total, it becomes possible to display a larger image on the screen 5 in comparison with the case where the second mirror 3 is not employed in a projection device. In other words, regarding a projection image having a certain size, it becomes possible to reduce the optical path length required for displaying the projection image.

Regarding the shape of the second mirror 3 viewed in the reference plane, the second mirror 3 has a relatively large curvature in the vicinity of the front edge (where the second mirror 3 is fixed to the mount 51 and where the uppermost incident ray is incident on the second mirror 3) of the second mirror 3, and the curvature of the second mirror 3 becomes smaller at a point closer to the rear edge (where the lowermost incident ray is incident on the second mirror 3).

The second mirror 3 has a relatively complicated surface shape. Therefore, in order to achieve easiness of manufacturing and reduction in total weight of the projection device 100, the second mirror 3 is made of plastic. More specifically, the second mirror 3 is formed by firstly performing injection molding using plastic material having a property of being able to easily achieve surface smoothness, such as acrylate resin, chloroethene, methacrylate, and polycarbonate, and secondly evaporating particles of metal such as aluminium on the surface of the second mirror 3 formed to have an aspherical shape.

When a certain time period elapses from the activation of the projection device 100, temperature increases by several tens of degrees in the inside of the case 50 due to heat generation by the light source 11. Since plastic has a linear expansion coefficient α=7×10⁻⁵/° C. which is higher than that of glass, a possibility that the second mirror 3 may deform due to temperature increase in the case 5 arises. In order to prevent the projection image from being considerably deformed by the deformation of the second mirror 3 due to temperature increase, the second mirror 3 is configured as follows.

For the purpose of explanation of the detailed structure of the second mirror 3, a deformation reference point is defined as follows. The deformation reference point is a point on the surface of the second mirror 3 and is regarded as a point which does not move even if the entire shape of the second mirror 3 is deformed by the heat expansion due to temperature changes, in a state where the second mirror 3 is fixed to the mount 51 in the case 50.

The deformation reference point is determined as indicated below depending on the number of fixing points of the fixing members used for fixing the second mirror 3. For example, if the number of fixing points is one, a geometrical barycenter of a fixing region (within which the fixing member catches a part of the second mirror 3 to fix it to the mount 51) is regarded as the deformation reference point. If the number of fixing points is two, a center of a hypothetical line connecting, on the surface of the second mirror 3, a geometrical barycenter of one fixing region (corresponding to one fixing point) and a geometrical barycenter of the other fixing region (corresponding to the other fixing region) is regarded as a deformation reference point. If the number of fixing points is larger than or equal to three, a geometrical barycenter of a hypothetical polygon formed by connecting geometrical barycenters of the fixing regions is regarded as a deformation reference point.

If the second mirror 3 is fixed to the mount 51 at two fixing points (regions) as shown in FIG. 3A, a center 3a of a hypothetical line P2 connecting geometrical barycenters is regarded as a deformation reference point.

FIG. 3C illustrates another example of installation of the second mirror 3. In FIG. 3C, the entire front edge part of the second mirror 3 is fixed to the mount 5 with a long fixing member 521. If the long fixing member 521 catches the entire edge part of the second mirror 3 to fix it to the mount 51, a geometrical barycenter 3b of the fixing region is regarded as a deformation reference point.

In general, the center of the screen 5 and the center of the second mirror 3 are located on a common X-Y plane. Therefore, if the corners 3L and 3R are regarded as the fixing regions, a deformation reference point is located in the reference plane. By thus defining the deformation reference point 3a, it is possible to maintain the symmetry of the second mirror 3 in the horizontal direction with respect to the deformation reference point 3a. Such advantages can also be attained by the example of installation shown in FIG. 3A.

In this embodiment, the second mirror 3 includes a rotationally-symmetrical shape whose rotation axis passes through the deformation reference point. Such a configuration makes it possible to fabricate the surface shape relatively easily.

As described above, by fixing the second mirror 3 with the fixing member, the second mirror 3 can be brought to a mechanically coupled state in which the ill effect to the projection image due to the heat expansion of the second mirror 3 can be avoided as described below in detail. Therefore, a state where the second mirror 3 is pressed by a supporting member (e.g., a blade spring) but is not in the mechanically coupled state, such a state of the second mirror 3 can not be regarded as a fixed state. Regarding a point (region) where the second mirror 3 is pressed by a blade spring, such a sate can not be regarded as a mechanically coupled state. In other words, regarding a point (region) where the second mirror 3 is pressed by a blade spring, such a region can not be regarded as a fixing region and can not be used for defining the deformation reference point. Regarding the supporting member 53 shown in FIG. 3B, a region where the second mirror 3 is pressed by the supporting member 53 can not be used for defining the deformation reference point.

Hereafter, the structure of the second mirror 3 is further explained using curvature of a curve formed by cutting the second mirror 3 in a plane which includes the deformation reference point of the second mirror 3 and which is perpendicular to the screen 5 (i.e., a plane including the deformation reference point of the second mirror 3 and in parallel with the X-Y plane). It is understood that this plane corresponds to the above described reference plane since the deformation reference point is in the reference plane.

Regarding a curved mirror made of plastic, it is impossible to avoid occurrence of deformation caused by temperature changes. If the change of curvature increases due to the deformation, the deformation of the projection image also increases. For this reason, in this embodiment, the second mirror 3 is configured such that the change of curvature due to heat expansion becomes smaller in a region (hereafter, referred to as a first region) further from a region (hereafter, referred to as a second region) including the deformation reference point. In other words, the first region of the second mirror 3 deforms so that the curvature in the first region does not change.

However, as described below, the change of curvature in the region (i.e., the second region) including the deformation reference point due to heat expansion can not be avoided. For this reason, in this embodiment, the shape of the second mirror 3 is designed to achieve the function of effectively suppressing the change of curvature by dividing the shape of the second mirror 3 into a region where the change of curvature can be suppressed and a region where the change of curvature can not be avoided and appropriately designing only the region where the change of curvature can be suppressed.

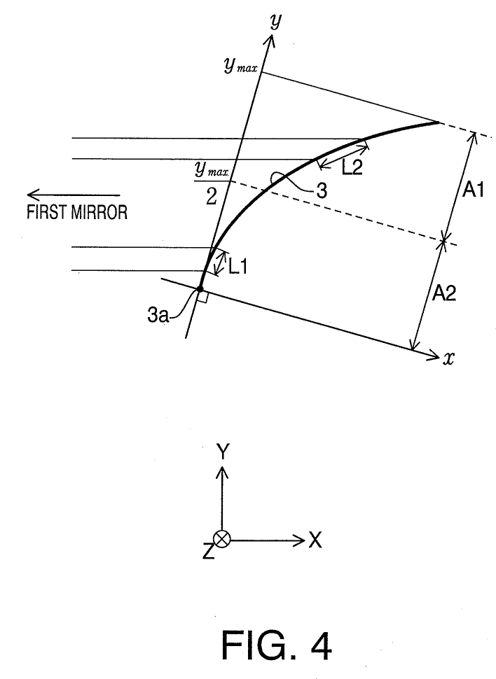

FIG. 4 is an enlarged view of the cross sectional shape of the second mirror 3 in the reference plane. In FIG. 4, the deformation reference point is defined as a point of origin, an axis tangent to the curve of the second mirror 3 at the deformation reference point 3a is defined as a y-axis, and an axis perpendicularly intersects with the y-axis in the reference plane is defined as an x-axis. In the x-y coordinate, the curve of the second mirror 3 is defined as a function having an argument y. A value of x defined by the function is called “a sag amount”.

As shown in FIG. 4, the first region is represented by “A1”, and the second region is represented by “A2”. Regarding yₘₐₓ defined in the vicinity of the position where the lowermost incident ray impinges on the second mirror 3 (i.e., position furthest from the deformation reference point 3a), the first region A1 is defined by yₘₐₓ=/2≦y≦yₘₐₓ, and the second region is defined by 0≦y≦yₘₐₓ/2.

The property of the change of curvature regarding the second mirror 3 will now be described in detail. The property of the curve (i.e., curved surface of the second mirror 3) is expressed by the second derivative of the function with y. When the sag amount x of the second mirror 3 in the room temperature is expressed as a function f(y), the curvature is expressed by f″(y) corresponding the second derivative of f(y). When the sag amount x of the second mirror 3 in a state where the temperature has increased by T degree from the room temperature is expressed as a function g(y), the curvature is expressed by g″(y) corresponding to the second deviate of g(y).

Regarding f(y) and g(y), a following equation (1) holds.

g(y)/(1+αT)=f(y/(1+αT)) (1)

By obtaining the second derivatives of the both sides of the equation (1) and then arranging the equation (1), the second derivative of g(y) (i.e., g″(y) which is curvature defined when the temperature in the case increases by T) can be expressed by the following equation (2) with f″(y) (i.e., the curvature defined when the inside of the case 50 is at the room temperature) which is the second derivative of f(y).

$$\begin{matrix}{g}^{″} ( y ) = \frac{1}{1 + α T} {f}^{″} ( y / ( 1 + α T ) ) \\ = \frac{1}{1 + α T} {f}^{″} ( \frac{( 1 - α T ) y}{( 1 + α T ) ( 1 - α T )} ) \\ \approx \frac{1}{1 + α T} {f}^{″} ( ( 1 - α T ) y )\end{matrix} \qquad ( 2 )$$

Hereafter, a detailed configuration of the first region A1 is described. By considering the optimum condition f″(y)=g″(y) in the first region A1, the condition expressed in the equation (2) can be rewritten to the following equation (3).

(1+αT)f″(y)=f″((1−αT)y) (3)

The shape of the second mirror 3 for achieving the condition where the shape is not affected by the heat expansion is defined as a shape satisfying a condition f″(y)≈g″(y). As can be seen from the equation (3), this shape can be expressed as a shape where the curvature deceases as a value of y increases and where the shape can be expressed approximately by a linear function. More specifically, by defining the shape of the second mirror 3 so that a property of the curvature of the shape of the second mirror 3 can be expressed by a linear function indicated in the following equation (5), it is possible to reduce the bad effect of the temperature change. The deformation reference point serving as a reference for y is positioned at a point which can be defined by the linear function of the equation (5). More specifically, as expressed by the right term of the following condition (6), the second mirror 3 is configured to have the surface shape defined by the following equation (5) or the surface shape having the curvature smaller than that defined by the equation (5)

$${f}^{″} ( y ) = - \frac{{f}^{″} ( {y}_{max} )}{{y}_{max}} y + 2 {f}^{″} ( {y}_{max} ) \qquad ( 5 )$$

For ymax/2≦y≦ymax,

$$\vert {f}^{″} ( y max ) \vert \leq \vert {f}^{″} ( y ) \vert \leq \vert 2 {f}^{″} ( y max ) \vert - \vert \frac{y}{y max} {f}^{″} ( y max ) \vert . \qquad ( 6 )$$

By satisfying the left term of the condition (6), irregular changes of shape in the peripheral part of the surface shape can be suppressed. The surface satisfying the condition (3) may be configured to further satisfy the following condition (7).

For ymax/2≦y≦ymax,

|f″(ymax)|≦|f″(y)|≦|2f″(ymax)| (7)

Regarding change of the curvature due to temperature changes, the curvature in the first region A1 of the surface shape satisfying the condition (6) changes in the same sign. Therefore, regarding change of the defocusing amount due to temperature changes, the defocus amount changes in the same sign. Such a configuration makes it possible to easily adjust the defocusing amount. By satisfying the condition (7), it becomes possible to form the surface shape of the second mirror 3 to be close to a spherical surface shape. Therefore, by satisfying the condition (7), easiness for fabrication of the surface shape can be achieved.

It is possible to suppress the deterioration of drawing performance due to temperature changes by configuring the projection device 100 such that the entire part of or the greater part of the drawing beam for forming the projection image impinges on the first region where the temperature compensating is achieved.

Regarding the equation (3), when y is 0, the equation (3) can be expressed by the following equation (4).

(1+αT)f″(0)=f″(0) (4)

The equation (4) means that the effect of reducing the deformation by temperature change can not be derived in the region in the vicinity of the deformation reference point. Therefore, it is not necessary that the above mentioned shape for reducing the deformation by temperature change is achieved on the entire region of the second mirror 3. The above mentioned shape for reducing the deformation by temperature change may be achieved only in the region further from the deformation reference point.

If a relatively large amount of light is incident on the second region A2, for example, to reduce the size of the second mirror 3, it is possible to suppress the deterioration of drawing performance due to temperature changes as follows. To explain the configuration of the second region A2, collimated beams impinging on the second mirror 3 as shown in FIG. 4 are considered. In FIG. 4, L1 represents a width of a beam spot formed on the surface of the second mirror 3 by the collimated beam having a smaller incident angle, and L2 represents a width of a beam spot formed in the surface of the second mirror 3 by the collimated beam having a larger incident angle. As can be seen from FIG. 4, the width of the beam spot L2 is larger than the width of the beam spot L1, which means that for a light beam having a small incident angle, the ill affect due to change of the curvature is small.

As described above regarding the first region A1, the cross sectional shape of the second mirror 3 in the reference plane is configured such that the curvature becomes smaller at a point closer to the rear edge. Considering such a fact, the projection unit 1, the first mirror 2, the second mirror 3, and the third mirror 4 are positioned so that the incident angle of the light beam impinging on the second mirror 3 in the vicinity of the deformation reference point 3a becomes small.

Consequently, regarding the second region A2, it becomes possible to prevent the projection image from being badly affected by the temperature changes even if the relationship expressed by the equation (3) is not satisfied. In other words, regarding the region in the vicinity of the deformation reference point 3a, it is not necessary to strictly apply the relationship expressed in the equation (3) to the design of the second region A2. By contrast, the region further from the deformation reference point, it is necessary to strictly apply the relationship expressed in the condition (3) to the design of the second mirror 3.

As described above, the configuration of the second mirror 3 is considered by dividing the surface shape into the first and second regions A1 and A2. Regarding the first region A1, change of f″(y) due to heat expansion is reduced to a minimum level by designing the deformation reference point to satisfy the above mentioned conditions so that the projection image is not badly affected. In addition, even if the projection device 100 includes the second region A2 where the f″(y) changes, it is possible to configure the projection device 100 such that the projection image is not badly affected, by appropriately arranging the internal components (i.e., by appropriately determining incident angles).

Hereafter, concrete examples (first to third) of the second mirrors satisfying the equation (5) and the condition (6) and a comparative example not satisfying the equation (5) and the condition (6) are described. In each of the following first to third examples and comparative examples, the linear expansion coefficient is 7×10⁻⁵/° C. In each of the first example, the third example and the comparative example, the maximum value yₘₐₓ of the curve (cross sectional shape) of the second mirror 3 in the reference plane is 170 mm (i.e., yₘₐₓ=170 mm, yₘₐₓ/2=85 mm). In the second example, the yₘₐₓ is 153 mm (i.e., yₘₐₓ=153 mm, yₘₐₓ/2=76.5 mm). In the following, the room temperature is regarded as 20° C.

### FIRST EXAMPLE

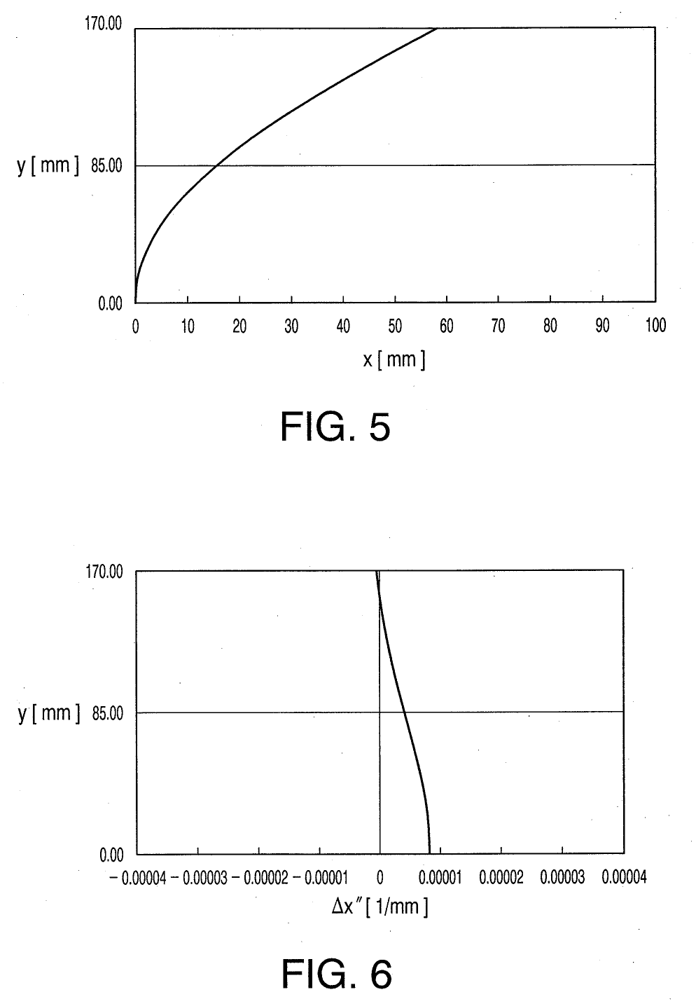

Table 1 shows the sag amount x, the gradient x′ (the first derivative of x with respect to y), the curvature x″ (the second derivative of x with respect to y) for defining the curve (the cross sectional shape) of the second mirror 3 according to the first example in the reference plane. In Table 1, x′ corresponds to f″(y), x″ corresponds to f″(y). In Table 1 (and in the following similar tables), a dashed line is illustrated to show a boundary (i.e., a position of yₘₐₓ/2) between the first region A1 and the second region A2. FIG. 5 illustrates the curve (the cross sectional shape) of the second mirror 3 having the values shown in Table 1.

TABLE 1

| y[mm] | x[mm] | x′ | x″ |
|---|---|---|---|
| 170.00 | 58.0288 | 0.6114 | 0.002252 |
| 165.75 | 55.4507 | 0.6017 | 0.002316 |
| 161.50 | 52.9144 | 0.5918 | 0.002381 |
| 157.25 | 50.4211 | 0.5815 | 0.002448 |
| 153.00 | 47.9720 | 0.5710 | 0.002515 |
| 148.75 | 45.5684 | 0.5601 | 0.002584 |
| 144.50 | 43.2114 | 0.5490 | 0.002654 |
| 140.25 | 40.9024 | 0.5376 | 0.002725 |
| 136.00 | 38.6426 | 0.5258 | 0.002797 |
| 131.75 | 36.4333 | 0.5138 | 0.002870 |
| 127.50 | 34.2759 | 0.5014 | 0.002944 |
| 123.25 | 32.1717 | 0.4888 | 0.003018 |
| 119.00 | 30.1220 | 0.4758 | 0.003093 |
| 114.75 | 28.1281 | 0.4625 | 0.003168 |
| 110.50 | 26.1915 | 0.4488 | 0.003244 |
| 106.25 | 24.3135 | 0.4349 | 0.003319 |
| 102.00 | 22.4954 | 0.4206 | 0.003394 |
| 97.75 | 20.7386 | 0.4060 | 0.003469 |
| 93.50 | 19.0445 | 0.3911 | 0.003543 |
| 89.25 | 17.4143 | 0.3759 | 0.003617 |
| 85.00 | 15.8495 | 0.3604 | 0.003689 |
| 80.75 | 14.3514 | 0.3446 | 0.003760 |
| 76.50 | 12.9211 | 0.3284 | 0.003830 |
| 72.25 | 11.5601 | 0.3120 | 0.003898 |
| 68.00 | 10.2694 | 0.2953 | 0.003964 |
| 63.75 | 9.0503 | 0.2783 | 0.004028 |
| 59.50 | 7.9040 | 0.2611 | 0.004089 |
| 55.25 | 6.8316 | 0.2436 | 0.004147 |
| 51.00 | 5.8340 | 0.2258 | 0.004202 |
| 46.75 | 4.9123 | 0.2079 | 0.004254 |
| 42.50 | 4.0675 | 0.1897 | 0.004302 |
| 38.25 | 3.3004 | 0.1713 | 0.004347 |
| 34.00 | 2.6118 | 0.1527 | 0.004387 |
| 29.75 | 2.0024 | 0.1340 | 0.004424 |
| 25.50 | 1.4729 | 0.1151 | 0.004455 |
| 21.25 | 1.0239 | 0.0961 | 0.004483 |
| 17.00 | 0.6558 | 0.0770 | 0.004505 |
| 12.75 | 0.3692 | 0.0579 | 0.004523 |
| 8.50 | 0.1641 | 0.0386 | 0.004535 |
| 4.25 | 0.0410 | 0.0193 | 0.004543 |
| 0.00 | 0.0000 | 0.0000 | 0.004545 |

Tables 2 shows the sag amount x, the gradient x′ (the first derivative of x with respect to y), the curvature x″ (the second derivative of x with respect to y) for defining the curve (the cross sectional shape) of the second mirror 3 in the reference plane when the second mirror 3 is deformed by the heat expansion by the temperature increase of 30° C. from the room temperature. In Table 2, x′ corresponds to g′(y), x″ corresponds to g″(y). FIG. 6 is a graph representing the difference in curvature between the curvature x″ in the room temperature and the curvature x″ defined when the temperature increases by 30° C. from the room temperature.

TABLE 2

| y[mm] | x[mm] | x′ | x″ |
|---|---|---|---|
| 170.00 | 57.9435 | 0.6107 | 0.002253 |
| 165.75 | 55.3684 | 0.6010 | 0.002316 |
| 161.50 | 52.8352 | 0.5910 | 0.002381 |
| 157.25 | 50.3449 | 0.5808 | 0.002448 |
| 153.00 | 47.8989 | 0.5702 | 0.002515 |
| 148.75 | 45.4983 | 0.5594 | 0.002584 |
| 144.50 | 43.1444 | 0.5483 | 0.002654 |
| 140.25 | 40.8384 | 0.5368 | 0.002725 |
| 136.00 | 38.5816 | 0.5251 | 0.002796 |
| 131.75 | 36.3753 | 0.5131 | 0.002869 |
| 127.50 | 34.2209 | 0.5007 | 0.002943 |
| 123.25 | 32.1196 | 0.4881 | 0.003017 |
| 119.00 | 30.0728 | 0.4751 | 0.003091 |
| 114.75 | 28.0818 | 0.4618 | 0.003166 |
| 110.50 | 26.1480 | 0.4482 | 0.003241 |
| 106.25 | 24.2728 | 0.4342 | 0.003316 |
| 102.00 | 22.4575 | 0.4200 | 0.003391 |
| 97.75 | 20.7034 | 0.4054 | 0.003466 |
| 93.50 | 19.0119 | 0.3905 | 0.003540 |
| 89.25 | 17.3844 | 0.3753 | 0.003613 |
| 85.00 | 15.8221 | 0.3598 | 0.003685 |
| 80.75 | 14.3264 | 0.3440 | 0.003756 |
| 76.50 | 12.8985 | 0.3279 | 0.003825 |
| 72.25 | 11.5397 | 0.3115 | 0.003893 |
| 68.00 | 10.2512 | 0.2948 | 0.003959 |
| 63.75 | 9.0342 | 0.2778 | 0.004022 |
| 59.50 | 7.8899 | 0.2606 | 0.004083 |
| 55.25 | 6.8193 | 0.2431 | 0.004141 |
| 51.00 | 5.8235 | 0.2254 | 0.004196 |
| 46.75 | 4.9034 | 0.2075 | 0.004247 |
| 42.50 | 4.0601 | 0.1893 | 0.004295 |
| 38.25 | 3.2944 | 0.1710 | 0.004340 |
| 34.00 | 2.6070 | 0.1525 | 0.004380 |
| 29.75 | 1.9987 | 0.1338 | 0.004416 |
| 25.50 | 1.4702 | 0.1149 | 0.004447 |
| 21.25 | 1.0220 | 0.0960 | 0.004474 |
| 17.00 | 0.6546 | 0.0769 | 0.004497 |
| 12.75 | 0.3685 | 0.0578 | 0.004514 |
| 8.50 | 0.1638 | 0.0385 | 0.004527 |
| 4.25 | 0.0410 | 0.0193 | 0.004534 |
| 0.00 | 0.0000 | 0.0000 | 0.004537 |

As shown in Table 1, |f″(yₘₐₓ)|=0.002252, |2f″(yₘₐₓ)|=0.004504. For yₘₐₓ/2≦y≦yₘₐₓ, f″(y) is larger than or equal to |f″(yₘₐₓ)| and smaller than or equal to |2f″(yₘₐₓ)|. Therefore, the first example satisfies the condition regarding the equation (5). As shown in FIG. 6, even if the ambient temperature increases, the curvature error is suppressed to a small level (i.e., smaller than 5.0×10⁻⁶) in the second region A2 (i.e., in yₘₐₓ/2≦y≦yₘₐₓ).

Regarding the first region A1 (0≦y≦yₘₐₓ/2), the curvature error is suppressed to a small level (i.e., smaller than 1.0×10⁻⁶). Therefore, the projection device 100 according to the first example is able to provide a high quality image which is not deformed even if the temperature change arises.

### SECOND EXAMPLE

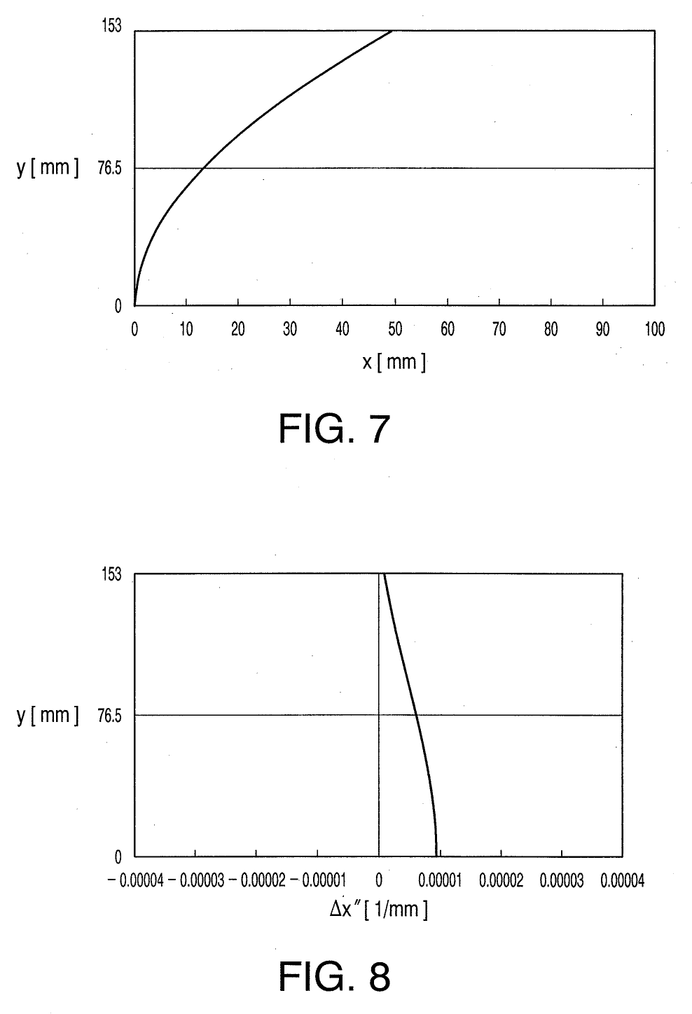

Table 3 shows the sag amount x, the gradient x′ (the first derivative of x with respect to y), the curvature x″ (the second derivative of x with respect to y) for defining the curve (the cross sectional shape) of the second mirror 3 according to the second example in the reference plane. In Table 3, x′ corresponds to f″(y), x″ corresponds to f″(y). FIG. 7 illustrates the curve (the cross sectional shape) of the second mirror 3 having the values shown in Table 3.

TABLE 3

| y[mm] | x[mm] | x′ | x″ |
|---|---|---|---|
| 153.00 | 48.8067 | 0.5891 | 0.002755 |
| 148.75 | 46.3281 | 0.5772 | 0.002821 |
| 144.50 | 43.9005 | 0.5651 | 0.002889 |
| 140.25 | 41.5250 | 0.5527 | 0.002956 |
| 136.00 | 39.2030 | 0.5400 | 0.003024 |
| 131.75 | 36.9355 | 0.5270 | 0.003093 |
| 127.50 | 34.7240 | 0.5137 | 0.003161 |
| 123.25 | 32.5695 | 0.5001 | 0.003230 |
| 119.00 | 30.4734 | 0.4862 | 0.003299 |
| 114.75 | 28.4369 | 0.4721 | 0.003367 |
| 110.50 | 26.4611 | 0.4576 | 0.003435 |
| 106.25 | 24.5475 | 0.4429 | 0.003503 |
| 102.00 | 22.6971 | 0.4278 | 0.003570 |
| 97.75 | 20.9112 | 0.4125 | 0.003637 |
| 93.50 | 19.1910 | 0.3969 | 0.003702 |
| 89.25 | 17.5376 | 0.3811 | 0.003766 |
| 85.00 | 15.9523 | 0.3649 | 0.003829 |
| 80.75 | 14.4361 | 0.3485 | 0.003891 |
| 76.50 | 12.9902 | 0.3319 | 0.003951 |
| 72.25 | 11.6156 | 0.3149 | 0.004009 |
| 68.00 | 10.3135 | 0.2978 | 0.004064 |
| 63.75 | 9.0847 | 0.2804 | 0.004118 |
| 59.50 | 7.9304 | 0.2628 | 0.004170 |
| 55.25 | 6.8513 | 0.2450 | 0.004218 |
| 51.00 | 5.8485 | 0.2269 | 0.004264 |
| 46.75 | 4.9226 | 0.2087 | 0.004307 |
| 42.50 | 4.0746 | 0.1903 | 0.004347 |
| 38.25 | 3.3051 | 0.1718 | 0.004384 |
| 34.00 | 2.6147 | 0.1531 | 0.004417 |
| 29.75 | 2.0041 | 0.1342 | 0.004446 |
| 25.50 | 1.4738 | 0.1153 | 0.004472 |
| 21.25 | 1.0244 | 0.0962 | 0.004494 |
| 17.00 | 0.6560 | 0.0771 | 0.004513 |
| 12.75 | 0.3692 | 0.0579 | 0.004527 |
| 8.50 | 0.1642 | 0.0386 | 0.004537 |
| 4.25 | 0.0410 | 0.0193 | 0.004543 |
| 0.00 | 0.0000 | 0.0000 | 0.004545 |

Table 4 shows the sag amount x, the gradient x′ (the first derivative of x with respect to y), the curvature x″ (the second derivative of x with respect to y) for defining the curve (the cross sectional shape) of the second mirror 3 according to the second example in the reference plane when the second mirror 3 is deformed by the heat expansion by the temperature increase of 30° C. from the room temperature. In Table 4, x′ corresponds to g′(y), x″ corresponds to g″(y). FIG. 8 is a graph representing the difference in curvature between the curvature x″ in the room temperature and the curvature x″ defined when the temperature increases by 30° C. from the room temperature.

TABLE 4

| y[mm] | x[mm] | x′ | x″ |
|---|---|---|---|
| 153.00 | 48.7299 | 0.5883 | 0.002754 |
| 148.75 | 46.2547 | 0.5765 | 0.002820 |
| 144.50 | 43.8303 | 0.5643 | 0.002887 |
| 140.25 | 41.4582 | 0.5519 | 0.002955 |
| 136.00 | 39.1394 | 0.5392 | 0.003023 |
| 131.75 | 36.8752 | 0.5262 | 0.003091 |
| 127.50 | 34.6668 | 0.5129 | 0.003159 |
| 123.25 | 32.5155 | 0.4994 | 0.003228 |
| 119.00 | 30.4225 | 0.4855 | 0.003296 |
| 114.75 | 28.3891 | 0.4714 | 0.003364 |
| 110.50 | 26.4164 | 0.4569 | 0.003432 |
| 106.25 | 24.5057 | 0.4422 | 0.003500 |
| 102.00 | 22.6582 | 0.4272 | 0.003567 |
| 97.75 | 20.8751 | 0.4119 | 0.003633 |
| 93.50 | 19.1577 | 0.3963 | 0.003698 |
| 89.25 | 17.5070 | 0.3804 | 0.003762 |
| 85.00 | 15.9243 | 0.3643 | 0.003824 |
| 80.75 | 14.4106 | 0.3479 | 0.003886 |
| 76.50 | 12.9672 | 0.3313 | 0.003945 |
| 72.25 | 11.5949 | 0.3144 | 0.004003 |
| 68.00 | 10.2950 | 0.2973 | 0.004059 |
| 63.75 | 9.0684 | 0.2799 | 0.004112 |
| 59.50 | 7.9161 | 0.2623 | 0.004163 |
| 55.25 | 6.8389 | 0.2445 | 0.004212 |
| 51.00 | 5.8379 | 0.2265 | 0.004257 |
| 46.75 | 4.9137 | 0.2083 | 0.004300 |
| 42.50 | 4.0671 | 0.1900 | 0.004340 |
| 38.25 | 3.2990 | 0.1715 | 0.004376 |
| 34.00 | 2.6099 | 0.1528 | 0.004409 |
| 29.75 | 2.0004 | 0.1340 | 0.004439 |
| 25.50 | 1.4711 | 0.1151 | 0.004464 |
| 21.25 | 1.0225 | 0.0961 | 0.004486 |
| 17.00 | 0.6548 | 0.0769 | 0.004504 |
| 12.75 | 0.3685 | 0.0578 | 0.004519 |
| 8.50 | 0.1639 | 0.0385 | 0.004529 |
| 4.25 | 0.0410 | 0.0193 | 0.004535 |
| 0.00 | 0.0000 | 0.0000 | 0.004537 |

As shown in Table 3, |f″(yₘₐₓ)|=0.002755, |2f″(yₘₐₓ)|=0.005510. For yₘₐₓ/2≦y≦yₘₐₓ, f″(y) is larger than or equal to |f″(yₘₐₓ)| and smaller than or equal to |2f″(yₘₐₓ)|. Therefore, the second example satisfies the condition regarding the equation (5). As shown in FIG. 8, even if the ambient temperature increases, the curvature error is suppressed to a small level (i.e., smaller than 6.0×10⁻⁶) in the second region A2 (i.e., in yₘₐₓ/2≦y≦yₘₐₓ).

Regarding the first region A1 (0≦y≦yₘₐₓ/2), the curvature error is suppressed to a small level (i.e., smaller than 8.0×10⁻⁶). Therefore, the projection device 100 according to the second example is able to provide a high quality image which is not deformed even if the temperature change arises.

Further, as can be seen from Table 3, the second example satisfies the condition (6). Therefore, it becomes possible to easily correct the defocus caused by the second mirror 3.

### THIRD EXAMPLE

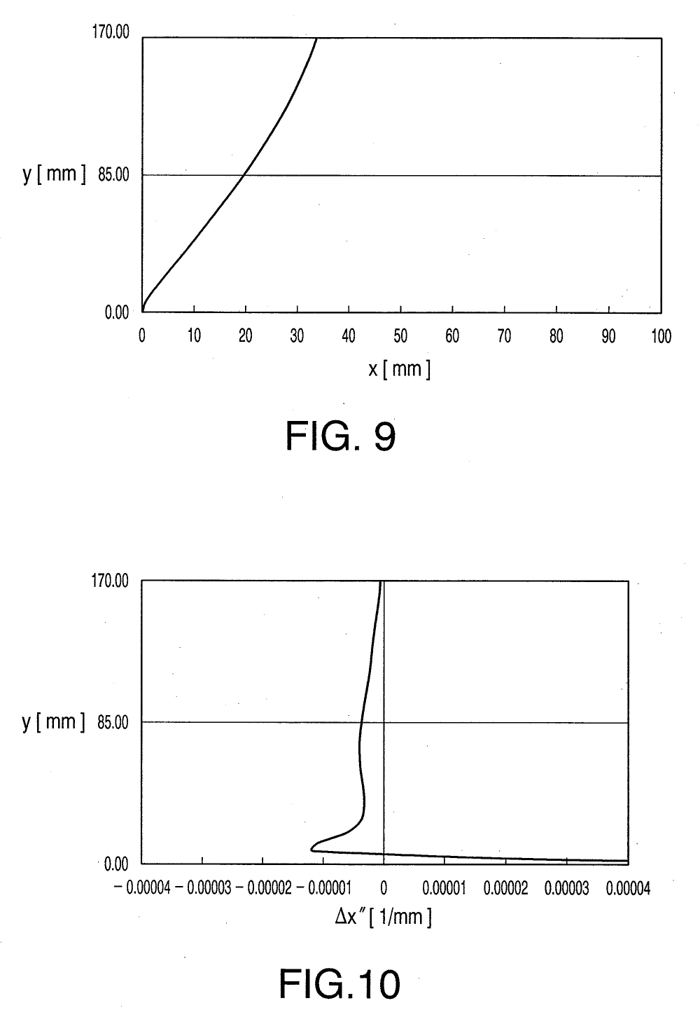

Table 5 shows the sag amount x, the gradient x′ (the first derivative of x with respect to y), the curvature x″ (the second derivative of x with respect to y) for defining the curve (the cross sectional shape) of the second mirror 3 according to the third example in the reference plane. In Table 5, x′ corresponds to f″(y), x″ corresponds to f″(y). FIG. 9 illustrates the curve (the cross sectional shape) of the second mirror 3 having the values shown in Table 5. As show in FIG. 9, the curve (the cross sectional shape) of the second mirror 3 according to the third example is difference from the curve of each of the first and second examples. More specifically, as shown in FIG. 9, the cross sectional shape of the second mirror 3 has a concave shape in the vicinity of the dashed line P3 (see FIG. 3A), and has a convex shape in the vicinity of the dashed line P1 or P2 (see FIG. 3A). It should be understood that even if the cross sectional shape having the concave shape and the convex shape shown in FIG. 9 is employed for the second mirror 3, the same advantages as those of the first and second examples can be achieved.

TABLE 5

| y[mm] | x[mm] | x′ | x″ |
|---|---|---|---|
| 170.00 | 33.5951 | 0.1124 | −0.001164 |
| 165.75 | 33.1068 | 0.1174 | −0.001175 |
| 161.50 | 32.5973 | 0.1224 | −0.001192 |
| 157.25 | 32.0663 | 0.1275 | −0.001211 |
| 153.00 | 31.5134 | 0.1327 | −0.001229 |
| 148.75 | 30.9382 | 0.1380 | −0.001246 |
| 144.50 | 30.3406 | 0.1433 | −0.001260 |
| 140.25 | 29.7202 | 0.1487 | −0.001272 |
| 136.00 | 29.0769 | 0.1541 | −0.001282 |
| 131.75 | 28.4104 | 0.1596 | −0.001291 |
| 127.50 | 27.7205 | 0.1651 | −0.001298 |
| 123.25 | 27.0073 | 0.1706 | −0.001303 |
| 119.00 | 26.2705 | 0.1761 | −0.001306 |
| 114.75 | 25.5101 | 0.1817 | −0.001308 |
| 110.50 | 24.7261 | 0.1872 | −0.001306 |
| 106.25 | 23.9185 | 0.1928 | −0.001300 |
| 102.00 | 23.0875 | 0.1983 | −0.001290 |
| 97.75 | 22.2332 | 0.2037 | −0.001274 |
| 93.50 | 21.3558 | 0.2091 | −0.001251 |
| 89.25 | 20.4559 | 0.2144 | −0.001222 |
| 85.00 | 19.5339 | 0.2195 | −0.001184 |
| 80.75 | 18.5906 | 0.2244 | −0.001138 |
| 76.50 | 17.6267 | 0.2291 | −0.001084 |
| 72.25 | 16.6432 | 0.2336 | −0.001020 |
| 68.00 | 15.6414 | 0.2378 | −0.000948 |
| 63.75 | 14.6224 | 0.2417 | −0.000866 |
| 59.50 | 13.5878 | 0.2452 | −0.000776 |
| 55.25 | 12.5392 | 0.2482 | −0.000677 |
| 51.00 | 11.4784 | 0.2509 | −0.000567 |
| 46.75 | 10.4073 | 0.2530 | −0.000446 |
| 42.50 | 9.3282 | 0.2547 | −0.000309 |
| 38.25 | 8.2436 | 0.2556 | −0.000150 |
| 34.00 | 7.1563 | 0.2559 | 0.000046 |
| 29.75 | 6.0700 | 0.2552 | 0.000306 |
| 25.50 | 4.9893 | 0.2531 | 0.000688 |
| 21.25 | 3.9215 | 0.2490 | 0.001316 |
| 17.00 | 2.8782 | 0.2412 | 0.002490 |
| 12.75 | 1.8817 | 0.2260 | 0.004973 |
| 8.50 | 0.9799 | 0.1943 | 0.010744 |
| 4.25 | 0.2824 | 0.1252 | 0.022985 |
| 0.00 | 0.0000 | 0.0000 | 0.033333 |

Table 6 shows the sag amount x, the gradient x′ (the first derivative of x with respect to y), the curvature x″ (the second derivative of x with respect to y) for defining the curve (the cross sectional shape) of the second mirror 3 according to the third example in the reference plane when the second mirror 3 is deformed by the heat expansion by the temperature increase of 30° C. from the room temperature. In Table 6, x′ corresponds to g′(y), x″ corresponds to g″(y). FIG. 10 is a graph representing the difference in curvature between the curvature x″ in the room temperature and the curvature x″ defined when the temperature increases by 30° C. from the room temperature.

TABLE 6

| y[mm] | x[mm] | x′ | x″ |
|---|---|---|---|
| 170.00 | 33.6220 | 0.1128 | −0.001163 |
| 165.75 | 33.1322 | 0.1177 | −0.001175 |
| 161.50 | 32.6211 | 0.1228 | −0.001191 |
| 157.25 | 32.0886 | 0.1279 | −0.001210 |
| 153.00 | 31.5342 | 0.1330 | −0.001228 |
| 148.75 | 30.9576 | 0.1383 | −0.001244 |
| 144.50 | 30.3585 | 0.1436 | −0.001258 |
| 140.25 | 29.7367 | 0.1490 | −0.001270 |
| 136.00 | 29.0919 | 0.1544 | −0.001280 |
| 131.75 | 28.4241 | 0.1599 | −0.001289 |
| 127.50 | 27.7329 | 0.1654 | −0.001296 |
| 123.25 | 27.0184 | 0.1709 | −0.001301 |
| 119.00 | 26.2803 | 0.1764 | −0.001304 |
| 114.75 | 25.5187 | 0.1820 | −0.001305 |
| 110.50 | 24.7336 | 0.1875 | −0.001303 |
| 106.25 | 23.9249 | 0.1930 | −0.001297 |
| 102.00 | 23.0928 | 0.1985 | −0.001287 |
| 97.75 | 22.2374 | 0.2040 | −0.001270 |
| 93.50 | 21.3592 | 0.2093 | −0.001248 |
| 89.25 | 20.4584 | 0.2146 | −0.001218 |
| 85.00 | 19.5356 | 0.2197 | −0.001180 |
| 80.75 | 18.5915 | 0.2246 | −0.001134 |
| 76.50 | 17.6269 | 0.2293 | −0.001080 |
| 72.25 | 16.6428 | 0.2338 | −0.001016 |
| 68.00 | 15.6404 | 0.2379 | −0.000944 |
| 63.75 | 14.6209 | 0.2418 | −0.000863 |
| 59.50 | 13.5859 | 0.2452 | −0.000772 |
| 55.25 | 12.5370 | 0.2483 | −0.000673 |
| 51.00 | 11.4759 | 0.2509 | −0.000564 |
| 46.75 | 10.4047 | 0.2531 | −0.000442 |
| 42.50 | 9.3254 | 0.2547 | −0.000306 |
| 38.25 | 8.2407 | 0.2557 | −0.000147 |
| 34.00 | 7.1534 | 0.2559 | 0.000049 |
| 29.75 | 6.0671 | 0.2551 | 0.000310 |
| 25.50 | 4.9866 | 0.2531 | 0.000692 |
| 21.25 | 3.9189 | 0.2489 | 0.001322 |
| 17.00 | 2.8759 | 0.2411 | 0.002497 |
| 12.75 | 1.8799 | 0.2259 | 0.004984 |
| 8.50 | 0.9787 | 0.1942 | 0.010756 |
| 4.25 | 0.2820 | 0.1250 | 0.022971 |
| 0.00 | 0.0000 | 0.0000 | 0.033271 |

As shown in Table 5, |f″(yₘₐₓ)|=0.001164, |2f″(yₘₐₓ)|=0.002328. For yₘₐₓ/2≦y≦yₘₐₓ, f″(y) is larger than or equal to |f″(yₘₐₓ)| and smaller than or equal to |2f″(yₘₐₓ)|. Therefore, the third example satisfies the condition regarding the equation (5). As shown in FIG. 10, even if the ambient temperature increases, the curvature error is suppressed to a small level (i.e., smaller than 5.0×10⁻⁶) in the second region A2 (i.e., in yₘₐₓ/2≦y≦yₘₐₓ).

Regarding the first region A1 (0≦y≦yₘₐₓ/2), the curvature error is approximately 4.0×10⁻⁴. As described above, the second mirror 3 is position such that the bad effect by change in curvature in the first region A1 can be reduced. By thus providing different properties for the first and second regions A1 and A2, the projection device 100 according to the third example is able to provide a high quality image which is not deformed even if the temperature change arises.

Further, as can be seen from Table 3, the third example satisfies the condition (6). Therefore, it becomes possible to easily correct the defocus caused by the second mirror 3.

### COMPARATIVE EXAMPLE

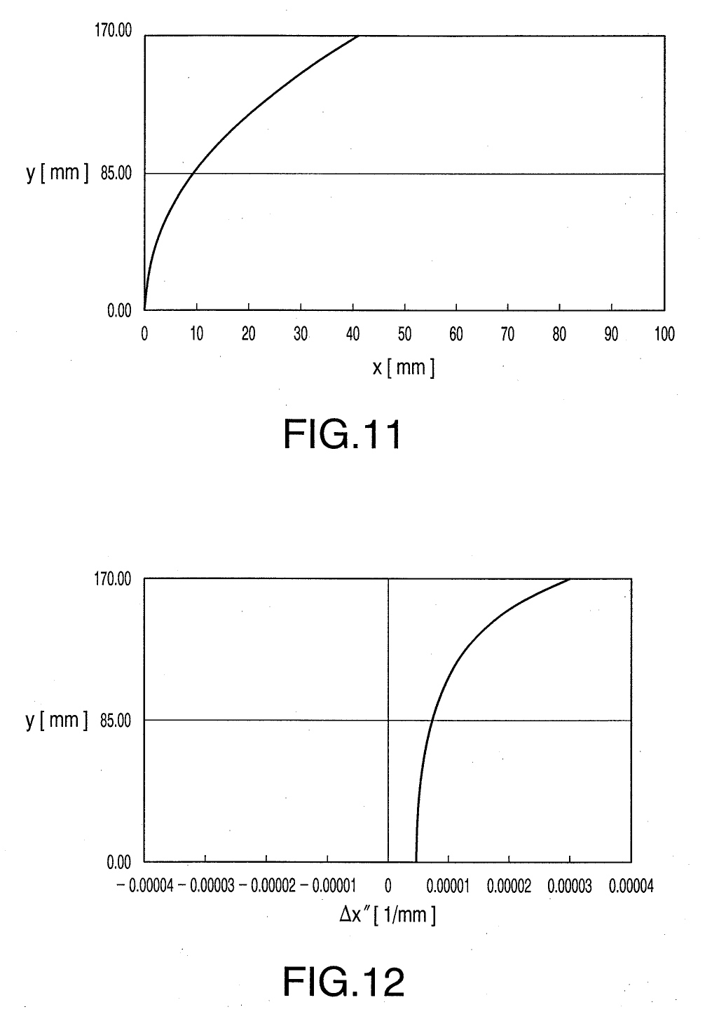

Table 7 shows the sag amount x, the gradient x′ (the first derivative of x with respect to y), the curvature x″ (the second derivative of x with respect to y) for defining the curve (the cross sectional shape in the reference plane) of the second mirror 3 according to the comparative example not satisfying the equation (5). FIG. 11 illustrates the curve (the cross sectional shape) of the second mirror 3 according to the comparative example based on the values shown in Table 7.

TABLE 7

| y[mm] | x[mm] | x′ | x″ |
|---|---|---|---|
| 170.00 | 40.6747 | 0.5475 | 0.005344 |
| 165.75 | 38.3954 | 0.5253 | 0.005093 |
| 161.50 | 36.2081 | 0.5041 | 0.004867 |
| 157.25 | 34.1088 | 0.4839 | 0.004663 |
| 153.00 | 32.0938 | 0.4645 | 0.004477 |
| 148.75 | 30.1596 | 0.4458 | 0.004308 |
| 144.50 | 28.3033 | 0.4279 | 0.004153 |
| 140.25 | 26.5220 | 0.4105 | 0.004012 |
| 136.00 | 24.8132 | 0.3937 | 0.003882 |
| 131.75 | 23.1745 | 0.3775 | 0.003763 |
| 127.50 | 21.6038 | 0.3617 | 0.003654 |
| 123.25 | 20.0991 | 0.3464 | 0.003553 |
| 119.00 | 18.6586 | 0.3315 | 0.003460 |
| 114.75 | 17.2807 | 0.3170 | 0.003373 |
| 110.50 | 15.9636 | 0.3028 | 0.003294 |
| 106.25 | 14.7061 | 0.2890 | 0.003220 |
| 102.00 | 13.5067 | 0.2755 | 0.003151 |
| 97.75 | 12.3642 | 0.2622 | 0.003088 |
| 93.50 | 11.2776 | 0.2492 | 0.003029 |
| 89.25 | 10.2456 | 0.2364 | 0.002975 |
| 85.00 | 9.2674 | 0.2239 | 0.002925 |
| 80.75 | 8.3421 | 0.2116 | 0.002878 |
| 76.50 | 7.4687 | 0.1994 | 0.002835 |
| 72.25 | 6.6466 | 0.1875 | 0.002796 |
| 68.00 | 5.8749 | 0.1757 | 0.002759 |
| 63.75 | 5.1531 | 0.1640 | 0.002725 |
| 59.50 | 4.4805 | 0.1525 | 0.002694 |
| 55.25 | 3.8566 | 0.1411 | 0.002666 |
| 51.00 | 3.2809 | 0.1298 | 0.002640 |
| 46.75 | 2.7528 | 0.1187 | 0.002617 |
| 42.50 | 2.2720 | 0.1076 | 0.002596 |
| 38.25 | 1.8381 | 0.0966 | 0.002577 |
| 34.00 | 1.4508 | 0.0857 | 0.002561 |
| 29.75 | 1.1097 | 0.0748 | 0.002546 |
| 25.50 | 0.8146 | 0.0640 | 0.002534 |
| 21.25 | 0.5653 | 0.0533 | 0.002523 |
| 17.00 | 0.3616 | 0.0426 | 0.002515 |
| 12.75 | 0.2033 | 0.0319 | 0.002508 |
| 8.50 | 0.0903 | 0.0213 | 0.002504 |
| 4.25 | 0.0226 | 0.0106 | 0.002501 |
| 0.00 | 0.0000 | 0.0000 | 0.002500 |

Table 8 shows the sag amount x, the gradient x′ (the first derivative of x with respect to y), the curvature x″ (the second derivative of x with respect to y) for defining the curve (the cross sectional shape) of the second mirror 3 according to the comparative example in the reference plane when the second mirror 3 is deformed by the heat expansion by the temperature increase of 30° C. from the room temperature. FIG. 12 is a graph representing the difference in curvature between the curvature x″ in the room temperature and the curvature x″ defined when the temperature increases by 30° C. from the room temperature.

TABLE 8

| y[mm] | x[mm] | x′ | x″ |
|---|---|---|---|
| 170.00 | 40.5775 | 0.5458 | 0.005315 |
| 165.75 | 38.3051 | 0.5237 | 0.005067 |
| 161.50 | 36.1243 | 0.5027 | 0.004843 |
| 157.25 | 34.0309 | 0.4825 | 0.004641 |
| 153.00 | 32.0215 | 0.4632 | 0.004457 |
| 148.75 | 30.0925 | 0.4446 | 0.004289 |
| 144.50 | 28.2411 | 0.4267 | 0.004136 |
| 140.25 | 26.4643 | 0.4095 | 0.003996 |
| 136.00 | 24.7598 | 0.3928 | 0.003868 |
| 131.75 | 23.1252 | 0.3766 | 0.003750 |
| 127.50 | 21.5583 | 0.3609 | 0.003641 |
| 123.25 | 20.0572 | 0.3456 | 0.003541 |
| 119.00 | 18.6201 | 0.3308 | 0.003448 |
| 114.75 | 17.2452 | 0.3163 | 0.003363 |
| 110.50 | 15.9311 | 0.3022 | 0.003284 |
| 106.25 | 14.6764 | 0.2884 | 0.003211 |
| 102.00 | 13.4796 | 0.2749 | 0.003143 |
| 97.75 | 12.3396 | 0.2616 | 0.003080 |
| 93.50 | 11.2552 | 0.2487 | 0.003022 |
| 89.25 | 10.2255 | 0.2360 | 0.002968 |
| 85.00 | 9.2493 | 0.2235 | 0.002918 |
| 80.75 | 8.3258 | 0.2112 | 0.002871 |
| 76.50 | 7.4543 | 0.1990 | 0.002829 |
| 72.25 | 6.6338 | 0.1871 | 0.002789 |
| 68.00 | 5.8636 | 0.1753 | 0.002753 |
| 63.75 | 5.1433 | 0.1637 | 0.002719 |
| 59.50 | 4.4720 | 0.1522 | 0.002689 |
| 55.25 | 3.8493 | 0.1408 | 0.002660 |
| 51.00 | 3.2746 | 0.1296 | 0.002635 |
| 46.75 | 2.7476 | 0.1184 | 0.002612 |
| 42.50 | 2.2677 | 0.1074 | 0.002591 |
| 38.25 | 1.8347 | 0.0964 | 0.002572 |
| 34.00 | 1.4481 | 0.0855 | 0.002556 |
| 29.75 | 1.1076 | 0.0747 | 0.002541 |
| 25.50 | 0.8131 | 0.0639 | 0.002529 |
| 21.25 | 0.5643 | 0.0532 | 0.002519 |
| 17.00 | 0.3609 | 0.0425 | 0.002510 |
| 12.75 | 0.2029 | 0.0319 | 0.002504 |
| 8.50 | 0.0902 | 0.0212 | 0.002499 |
| 4.25 | 0.0225 | 0.0106 | 0.002496 |
| 0.00 | 0.0000 | 0.0000 | 0.002495 |

As shown in FIG. 12, even if the ambient temperature increases, the change in curvature in the first region A1 is suppressed to a small level (i.e., smaller than 6.0×10⁻⁶). However, in the second region A2, the change in curvature reaches to a relatively large value of larger than or equal to 3.0×10⁻⁵. Therefore, if the second mirror 3 according to the comparative example is used, the projection image is deformed by temperature changes.

This application claims priority of Japanese Patent Application No. P2006-181749, filed on Jun. 30, 2006. The entire subject matter of the application is incorporated herein by reference.

What is claimed is:

1. A projection device, comprising:
an optical projection system from which a light beam for forming an image emerges;
a curved mirror on which the light beam from the optical projection system impinges;
a screen having a landscape rectangular shape; and
a light guiding unit that guides the light beam reflected from the curved mirror to the screen,
wherein:
when a direction corresponding to a thickness of the screen is defined as a X-direction, a direction corresponding to a shorter side of the screen is defined as a Y-direction, and a direction corresponding to a longer side of the screen is defined as a Z-direction,
a cross sectional shape of the curved mirror in an X-Z plane has a negative power in a range within which the light beam from the optical projection system impinges, and the curved mirror is fixed to the projection device through at least one predetermined fixing point;
a cross sectional shape of the curved mirror in an X-Y plane including a deformation reference point defined based on the at least one fixing point has its maximum negative power in a vicinity of the deformation reference point; and
a sag amount x=f(y) which is a sag amount of the cross sectional shape of the curved mirror in the X-Y plane and which is defined in an x-y coordinate having an origin point at the deformation reference point in the X-Y plane satisfies a following expression:
for ymax/2≦y≦ymax,

|f″(ymax)|≦|f″(y)|≦|2f″(ymax)|

where y represents an axis tangential to the cross sectional shape in the X-Y plane at the deformation reference point, x represents a normal to the cross sectional shape in the X-Y plane at the deformation reference point, f″(y) represents a second derivative of f(y) with respect to y, and yₘₐₓ, represents a value of y on the curved mirror at a point furthest from the deformation reference point in a use range of the curved mirror.

2. The projection device according to claim 1, wherein:
for yₘₐₓ/2≦y≦yₘₐₓ, the sag amount of the curved surface in the X-Y plane satisfies a condition:
$$\vert {f}^{″} ( y max ) \vert \leq \vert {f}^{″} ( y ) \vert \leq \vert 2 {f}^{″} ( y max ) \vert - \vert \frac{y}{y max} {f}^{″} ( y max ) \vert$$

3. The projection device according to claim 1, wherein the optical projection system is arranged in relation to the curved mirror such that the light beam from the optical projection system forms its minimum incident angle with respect to the curved mirror in the vicinity of the deformation reference point.

4. The projection device according to claim 1, wherein the curved mirror is formed to be a rotationally symmetrical shape and a rotation axis of the curved mirror passes through the deformation reference point.

5. The projection device according to claim 1, wherein the deformation reference point is located in the X-Y plane including a center of the screen.

6. The projection device according to claim 1, the at least one predetermined fixing point comprises two fixing points respectively located at a same distance in the Z-direction from an intersection line of the X-Y plane including a center of the screen and the curved surface.

7. The projection device according to claim 1, wherein the at least one predetermined fixing point is defined as an entire part of a predetermined edge region of the curved mirror situated on a bottom side of the projection device.

8. The projection device according to claim 1, further comprising a case that accommodates the optical projection system and the curved mirror,
wherein:
the screen is placed on a side of the case; and
the light guiding unit is attached to a top of the case.
